(19) United States
(12) Patent Application Publication
(10) Pub. No.: US 2024/0011350 A1
(43) Pub. Date: Jan. 11, 2024

(54) REVOLVING DOOR AND METHOD FOR ASSEMBLING A REVOLVING DOOR

(71) Applicant: dormakaba Deutschland GmbH, Ennepetal (DE)

(72) Inventors: Tim Wulbrandt, Ennepetal (DE); Daniel Fabri, Ennepetal (DE); Thomas Irrgang, Ennepetal (DE); Bernhard Heitz, Ennepetal (DE); Thomas Uebelgünne, Ennepetal (DE)

(21) Appl. No.: 18/345,474

(22) Filed: Jun. 30, 2023

(30) Foreign Application Priority Data
Jul. 11, 2022 (EP) 22184164.6

(51) Int. Cl. E06B 3/90

(52) U.S. Cl. CPC E06B 3/90; E05Y 2900/132

(57) ABSTRACT

A revolving door and a method for producing a revolving door are provided with a turnstile which is arranged between opposing barrel elements and with a ceiling assembly which is arranged on top of the barrel elements and on which the turnstile is rotatably mounted. The barrel elements each have an inner glass element and an outer glass element, with the ceiling assembly resting on a top finishing surface of the inner glass element.

### CROSS-REFERENCE TO RELATED APPLICATIONS

This application claims the benefit of European patent application 22184164.6 filed 11 Jul. 2022, the disclosure of which is incorporated herein by reference in its entirety.

### TECHNICAL FIELD

The disclosure relates to a revolving door with a turnstile which is arranged between opposing barrel elements and with a ceiling assembly which is arranged on top of the barrel elements and on which the turnstile is rotatably mounted. Furthermore, the disclosure relates to a method for assembling a revolving door.

### BACKGROUND

EP 1 605 128 B1 discloses an example of a revolving door with a turnstile which is arranged between opposing barrel elements and with a ceiling assembly which is arranged on top of the barrel elements and on which the turnstile is rotatably mounted. The revolving door thus comprises two opposing barrel elements with a turnstile arranged therebetween, and the ceiling assembly is located on top of the turnstile and merges physically and structurally with the barrel elements. The ceiling assembly is shown as forming a supporting structure with the barrel elements, and the ceiling assembly has connecting elements arranged in the center of the revolving door, and supports extending radially therefrom are provided, and within the barrel walls and beneath the ceiling assembly is arranged the turnstile, with the supports extending from the center to the barrel walls being held under pretension to create an upward force on the connecting elements.

Disadvantageously, this results in a high ceiling assembly which must be supported on beams or stanchions arranged on the outside of the barrel elements.

Another exemplary embodiment of a revolving door is known from EP 3 611 326 B1. Here, too, it can be seen that the design of the ceiling assembly is complex and must be assembled on-site in structural unity with the barrel elements. In particular, the barrel elements have struts on which the ceiling assembly rests.

### SUMMARY

The disclosure simplifies the assembly of a revolving door, in particular to simplify the connection of the ceiling assembly to the barrel walls, which is also to be arranged, as far as possible, on top of the elements so as to be detachable, and on which, lastly, the turnstile is accommodated in a rotatably mounted manner. In particular, the on-site assembly of the revolving door should be considerably simplified and the time required for this should be reduced by an improved ceiling assembly. The ceiling assembly should thereby, as far as possible, not be high and should be enclosed in the barrel walls. A further object of the disclosure is to improve the appearance and/or the functionality of the revolving door as a whole.

This is achieved proceeding from a revolving door according to the preamble of the claim 1 and a method according to claim 13 each with the characterizing features. Advantageous further developments of the disclosure are indicated in the dependent claims.

The disclosure achieves the above advantage wherein the barrel elements each have an inner and an outer glass element, with the ceiling assembly resting directly or indirectly on a top finishing surface of the respective inner glass element and/or on a bottom finishing surface of the outer glass element. In this context, the glass material can be designed in different ways, in particular as plastic glass or the like.

The barrel elements are preferably design entirely or at least predominantly of curved glass elements such that each barrel element has an inner glass element and an outer glass element such that this arrangement advantageously accommodates the ceiling assembly. The glass elements can thereby also have a rigidity, load-bearing capacity and strength, in particular due to their curvature, which is sufficient to accommodate the ceiling assembly, in particular with regard to the weight and other external forces. The at least one barrel element can have more than two, in particular three or four, glass elements.

By resting the ceiling assembly on the top finishing surface of the inner glass element and/or on a top finishing surface of the outer glass element, the load of the ceiling assembly can be transferred from the components of the barrel elements. When the ceiling assembly rests on the top finishing surface of the inner glass element, the ceiling assembly may be at least partially hidden by the outer glass element. In other words, the finishing surface of the inner glass element or the top finishing surface of the outer glass element forms the top edge side of the inner glass element or of the outer glass element, which can for example have a thickness of 6 mm to 20 mm and preferably 8 mm to 16 mm. The ceiling assembly can rest directly or indirectly on the top finishing surface, such that it is also conceivable that an intermediate element, an intermediate layer, an adhesive or a profile element is present between the ceiling assembly and the top finishing surface of the inner glass element such that even then, within the meaning of the present disclosure, the ceiling assembly rests on the top finishing surface of the inner glass element without the ceiling assembly and the glass element touching or having to directly adjoin one another.

Particularly advantageously, the inner glass element has a shorter vertical length or height, in particular in the installed state of the revolving door, than the outer glass element, such that the outer glass element encloses the ceiling assembly at least partially or entirely on the outside, in particular with regard to the height and/or with regard to the circumference of the ceiling assembly, preferably in the installed state of the revolving door, in particular when the ceiling assembly rests on the top finishing surface of the inner glass element and/or on a top finishing surface of the outer glass element. In this way, a top offset can result between the inner and the outer glass element such that the ceiling assembly can dip between the barrel elements. The information regarding the height relates in particular to the installed state of the revolving door.

Preferably, at least one of the barrel elements has a top offset between the inner glass element and the outer glass element. The top finishing surface of the outer glass element is preferably higher than the top finishing surface of the inner glass element. Thus, the ceiling assembly can dip between the barrel elements. The top offset relates in particular to the installed state of the revolving door. The offset can result, for example, from the fact that the glass elements have different heights or are offset in height from one another.

For example, the vertical length of the inner glass element can be shorter than the vertical length of the outer glass element, for example, by at least 20% to 100%, preferably by at least 50% to 100%, and particularly preferably by at least 80% to 100%, in particular by 60% or 70% of the height of the ceiling assembly. In other words, the outer glass element does not have to extend over the entire height of the ceiling assembly on the outside and cover it; for example, the ceiling assembly can also be covered on the outside with the outer glass element at only a partial height. The lateral covering of the ceiling assembly is also only in the region of the barrel elements, which, in a manner known per se, do not completely enclose the revolving door but only over part of its circumference, such that the revolving door has entry and exit sides for people to access.

At least one of the barrel elements preferably has a lateral offset, in particular on both sides, between the inner glass element and the outer glass element. In particular, the offset is present in the installed state of the revolving door. A support profile, in particular a post, can be arranged in an offset of this type. This support profile can be connected to the barrel elements and/or the ceiling assembly, in particular in a materially-bonded and/or force-fitting and/or form-fitting manner. The support profile can thereby dip statically and/or visually into the barrel element and thus further improve the view or statics. The support profile can thereby be dimensioned and/or arranged such that it ends flush with the barrel element in its circumferential profile and/or in its radial profile inwards or outwards. This means that the maximum degree of visual or static integration into the barrel element can be achieved. It is also conceivable that the region of the lateral offset is coated and/or colored in order to further improve the appearance.

Preferably, the inner glass element has a shorter horizontal length or width than the outer glass element, in particular in the installed state of the revolving door, or the outer glass element has a shorter horizontal length or width than the inner glass element, in particular in the installed state of the revolving door, such that a lateral offset occurs on at least one of the barrel elements. In particular, this does not mean that the inner glass element is only shorter in width because it is arranged on the inside such that both glass elements end flush at the sides.

It is also conceivable that the inner glass element and the outer glass element of one barrel element have the same horizontal length but are arranged offset from one another. In this way, the inner glass element would overhang on one side of the barrel element and the outer glass element would overhang on an opposite side. This would result in a lateral offset, which is formed differently depending on the side of the barrel element.

The ceiling assembly can be designed to be modular and have a sandwich design such that at least one filler is provided as the core material, and the filler has a cover panel on at least one cover surface or both cover surfaces. In this respect, only one top cover panel, only one bottom cover panel or one top and one bottom cover panel can be provided, which preferably run parallel to one another and between which the filler is located. It is also conceivable that further cover panels are present, which penetrate the filler and, for example, form a cover panel intermediate level.

An intermediate level may be necessary, for example, to increase the rigidity of the ceiling assembly and to accommodate components within the ceiling assembly or to hold them together or stiffen them together in their overall structure. The basic idea, however, is a sandwich design that enables a ceiling assembly that can be handled in a modular manner, which can be connected as a whole to the barrel elements on-site, in particular can be placed on top of the barrel elements, preferably with the turnstile being accommodated in a rotatable manner between the barrel elements.

Thus, the modular ceiling assembly preferably results in an assembly which can be handled individually and can be attached to the barrel elements and/or the turnstile, and can be detached again, in particular reversibly, from the barrel elements and/or the turnstile. For example, the ceiling assembly can be prefabricated at the factory such that the ceiling assembly only has to be connected to the barrel elements and the turnstile at the destination, without the basic components of the ceiling assembly having to be assembled or joined on-site. This results in significantly shorter assembly times and the general design of the ceiling assembly is simplified. According to the idea of the disclosure, the ceiling assembly is, in this regard, designed as a module, which can be attached to the other components of the revolving door and which can be arranged on the barrel walls and the turnstile and can also be removed from the position of the arrangement again.

According to a further embodiment, the basic design of the ceiling assembly provides that structural elements and/or functional elements are accommodated at least partially at or over the bottom cover panel and/or at or over the top cover panel, in particular in the region of the filler. It goes without saying that structural elements and/or functional elements can also protrude laterally, that is to say in particular projecting radially or from the cover panels at the top or bottom. In particular, the structural elements and/or functional elements can be surrounded by the filler or they are embedded in the filler. For example, a disc motor for driving the turnstile in a rotatable manner can be arranged on the bottom of the ceiling assembly such that it is for example partially integrated within the ceiling assembly and partially protrudes from it. Motors of this type are also referred to as torque or pancake motors and are usually connected to the turnstile without gears. The same applies, for example, to connecting elements for connecting the ceiling assembly to the barrel elements or to top structural elements of a building facade, which can also protrude out of the basic structure of the ceiling assembly in sections.

The structural elements can, for example, pass through the ceiling assembly diametrically and/or the structural elements can connect the top and the bottom cover panels to one another or be connected to just one cover panel. Although the filler is placed between the cover panels such that it surrounds the structural elements and/or the functional elements, the structural elements and/or the functional elements may also divide the filler into a plurality of partial elements, when the elements completely traverse the ceiling assembly, for example. With regard to the structural elements, it is conceivable, for example, to have a framework-like design, a star-shaped design or, for example, a rectangular or hexagonal design in order to correspondingly stiffen the ceiling assembly.

Furthermore, the bottom cover panel, but if necessary also the top cover panel, has openings, such that functional elements can be arranged in connection with the openings. The optional openings in the top and/or bottom region of the ceiling assembly, but if necessary also in the lateral circumferential region, enable the integration of functional elements on-site, for example a drive, a controller, a sensor device, a light device, a loudspeaker device, a power supply, a lock, a ventilation device, a heating element and/or the like, which can be introduced into the openings or into other recesses or intermediate regions in the filler.

The inner glass element and the outer glass element can be connected to one another particularly advantageously in a materially-bonded manner. In particular, the inner and outer glass elements can together form a laminated safety glass (LSG), which means that the barrel walls are particularly strong and can be designed to be break-proof. For example, it is advantageous for the inner glass element and the outer glass element to be connected to one another by means of at least one plastic film. In the production of this glass composite, the inner glass element can be provided with a correspondingly shorter vertical height and connected to the outer glass element.

Further advantageously, a profile element is provided which rests on the top finishing surface of the inner glass element and/or on a top finishing surface of the outer glass element, with the ceiling assembly being accommodated in or on the profile element. The profile element is thereby preferably adhered to the inner glass element and/or to the outer glass element, for example via the top finishing surface of the inner glass element and via the inner surface of the outer glass element. Alternatively or additionally, the profile element can also be adhered to the ceiling assembly or attached with fastening means so as to be detachable.

The profile element preferably has a first leg and a second leg, which is also designed to be perpendicular, such that the profile element has in particular an L shape or a T shape or a Z shape, in particular with the first leg resting on the finishing surface of the inner glass element and/or with the second leg adjoining the inside of the outer glass element. In particular, the profile element can have the same curvature as the curvature of the glass elements such that the profile element can be inserted accordingly into the inside of the glass elements. In the Z-shape, one or both of the parallel legs may be at right angles to the transverse leg.

At least one region of the outer glass element, which surpasses the inner glass element in height, can particularly advantageously have a coating or be colored or be designed as clear glass. This means that a viewer from the outside does not see the ceiling assembly through the outer glass element, and it is correspondingly covered. It is thereby conceivable that the coating of the inside of the outer glass element has free regions if, for example, sensors are arranged on the inside of the outer glass element and are arranged in particular in or on the ceiling assembly.

Furthermore, at least one support profile can be configured on the outside of the barrel elements, which has a preferably supporting connection with the ceiling assembly. For example, it is conceivable that the support profile extends vertically on the outside of the barrel elements and has a height that is the same as the height of the outer glass element or surpasses it slightly. If the ceiling assembly has structural elements, these can be connected to the support profile, and the support profile can also serve as a connection profile for a facade or wall in or on which the revolving door is arranged or configured.

It is also conceivable that at least one of the barrel elements has a display and/or one of the leaf elements, in particular an LCD, for displaying information. The appearance and/or the functionality of the revolving door can thus be further improved. In particular, the display can be arranged on or in or behind the inner glass element.

It is also conceivable for the display to be designed for interaction with a person, in particular by means of touch input, preferably with the interaction enabling the rotation speed of the turnstile to be stopped and/or changed. In particular, an emergency stop of the rotation can thus be executed by a user, a person inside the revolving door. In particular, this is an improvement over conventional systems where an emergency stop function is only possible from outside the revolving door. The security of the users can thus be increased even in unforeseeable situations.

The disclosure is also achieved by providing a method for assembling a revolving door, which is designed according to the features listed above, with the method comprising at least the following steps: Connecting an inner, in particular bent or curved, glass element, which is shorter in height, to an outer, in particular bent or curved, glass element, which is longer in height, Positioning the barrel elements in an opposing arrangement, and preferably: Placing a ceiling assembly directly or indirectly on a top finishing surface of the inner glass element and/or on a top finishing surface of the outer glass element. The information regarding the height relates in particular to the installed state of the revolving door.

To form the barrel elements, the inner glass elements can be adhered to the outer glass elements in a materially-bonded manner or connected to one another at least by means of a film, in particular to form laminated safety glass (LSG).

Furthermore, the ceiling assembly can be adhered to the barrel elements, in particular by arranging a profile element on the inner glass element and/or on the outer glass element. In addition, a profile element can be configured, which is placed on the top finishing surface of the inner glass element and on which the ceiling assembly is accommodated. In this way, an improved load transfer from the ceiling assembly to the inner and, partly also, the outer glass element is achieved.

Particularly advantageous, the ceiling assembly can be detachably adhered or detachably screwed or clamped to the barrel elements and in particular to the profile element after the profile element has been adhered to the inner and/or outer glass element and/or to the ceiling assembly.

It should be explicitly mentioned that features of the method can be transferred to the revolving door according to the disclosure and vice versa as according to the disclosure.

### BRIEF DESCRIPTION OF THE DRAWINGS

Further measures that improve the disclosure will be outlined in greater detail below together with the description of a preferred exemplary embodiment of the disclosure on the basis of the figures, in which is shown:

FIG. 1 an overall view of the revolving door with a design according to the disclosure,

FIG. 2 an overhead view of the components of the revolving door,

FIG. 3 a detailed view of the transition of the ceiling assembly into a barrel element,

FIG. 4 a perspective view of the top arrangement of the ceiling assembly on the barrel elements,

FIG. 5 a further detailed view of the arrangement of the ceiling assembly on a barrel element, and

FIG. 6a/b two top views of one barrel element each.

### DETAILED DESCRIPTION OF THE DRAWINGS

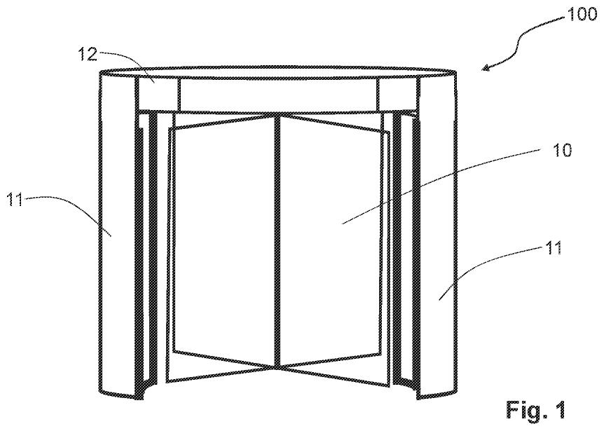

FIG. 1 shows the revolving door 100 with a turnstile 10 which is accommodated in a rotatable manner between two barrel elements 11. On top of the turnstile 10 is the ceiling assembly 12, which is designed to be modular and is accommodated as an assembly on the barrel elements 11. The turnstile 10 is rotatably mounted on the floor and bottom of the ceiling assembly 12.

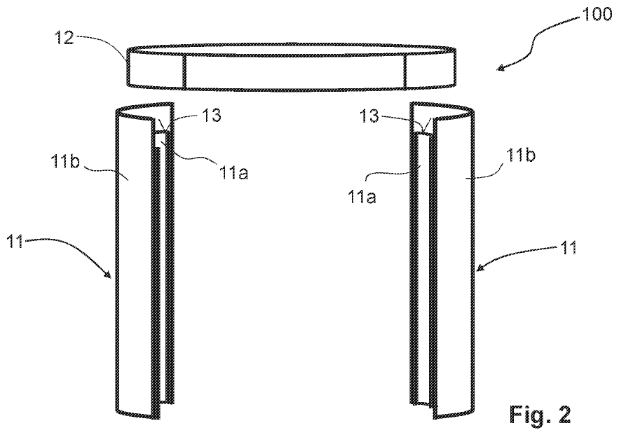

FIG. 2 shows an overhead view of the components of the revolving door 100 with the barrel elements 11 designed to accommodate the ceiling assembly 12 at the top. For this purpose, the barrel elements 11 have an inner glass element 11a and an outer glass element 11b, with the inner glass element 11a having a shorter vertical length than the outer glass element 11b such that the outer glass element 11b surpasses the inner glass element 11a and encloses the ceiling assembly 12 at least partially or entirely on the outside when the ceiling assembly 12 rests at least indirectly on the top finishing surface 13 of the inner glass element 11a. The view shows that the outer glass element 11b surpasses the inner glass element 11a by approximately the structural height of the ceiling assembly 12. When the ceiling assembly 12 is arranged on the barrel elements 11, the top edge of the outer glass panel 11b ends approximately flush with the top of the ceiling assembly 12.

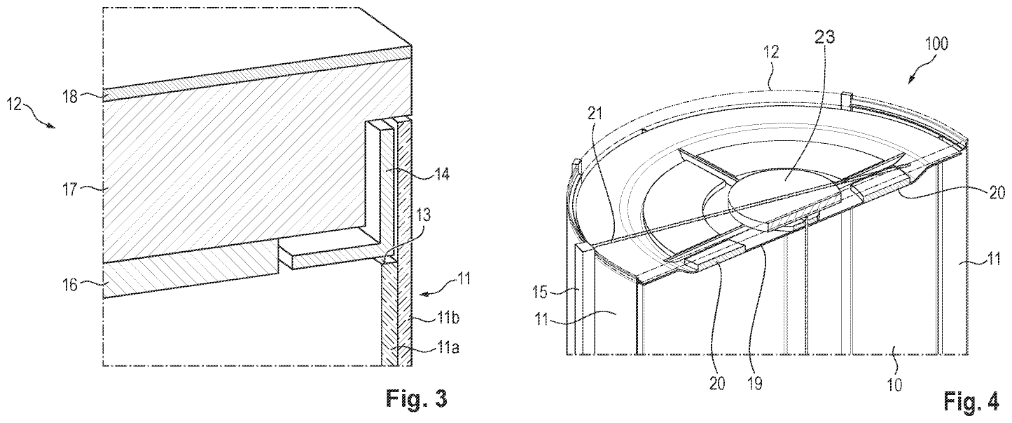

FIG. 3 shows in perspective a detailed view of the arrangement of the ceiling assembly 12 on a barrel element 11. The ceiling assembly 12 is designed with a bottom cover panel 16 and a top cover panel 18, between which a filler 17 is introduced in a sandwiched manner. The barrel element 11 has the inner glass element 11a and the outer glass element 11b, and the outer glass element 11b surpasses the inner glass element 11a on the outside in its height direction extension. The height difference between the top finishing surface 13 of the inner glass element 11a and the top edge of the outer glass element 11b corresponds to a partial height of the ceiling assembly 12 such that this exemplary embodiment shows that the barrel element 11 not completely, but at least partially, encloses the ceiling assembly 12 on the outside.

On the inside of the barrel element 11 is arranged a profile element 14, which rests with vertical leg on the inside of the outer glass element 11b and protrudes radially inwards with a horizontally running leg into the revolving door such that the ceiling assembly 12 can rest on the horizontally running leg. The profile element 14 sits on the finishing surface 13 of the inner glass element 11a and forms a simple angle profile. The profile element 14 is thus arranged between the ceiling assembly 12 and the barrel element 11, and the ceiling assembly 12 is in this respect only indirectly arranged on the barrel element 11, which represents a variant included in the disclosure, and the ceiling assembly 12 can also rest on the barrel element 11 directly, for example with the bottom cover panel 16 or with the filler or with a structural element present therein or even with an externally protruding edge of the top cover panel 18.

FIG. 4 shows in a further view the arrangement of the ceiling assembly 12 on top of the barrel elements 11, with the ceiling assembly 12 being shown with a structural part 21 which is connected to a support profile 15 arranged on the outside of the front barrel element 11.

On the underside of the ceiling assembly 12, the revolving door 100 has a ceiling device 19, which in particular can be designed to rotate with the turnstile 10 and is configured to be approximately parallel to the bottom of the ceiling assembly 12. The ceiling device 19 has, for example, light means 20 which, however, can also only have transparent surface bodies, and the actual light means can be configured in the ceiling assembly 12. A motor 23 is located in the center of the ceiling assembly 12, which is designed, for example, as an electronically commutated disc motor and is connected to the turnstile 10 without gears. The ceiling device 19 can thereby also rotate together with the turnstile 10 with the rotating part of the motor 23.

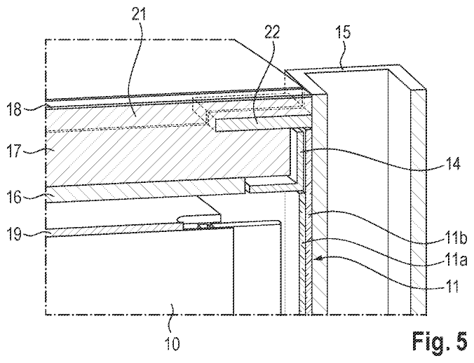

Lastly, FIG. 5 shows a further detailed view of the arrangement of the ceiling assembly 12 on a barrel element 11, with the profile element 14 resting on the top finishing surface 13 of the inner glass element 11a and adjoining the inside of the outer glass element 11b. A connecting means 22, which is connected to a structural part 21 of the ceiling assembly 12, is shown at the top of the profile element 14. The ceiling assembly 12 in turn has the bottom cover panel 16, the filler 17 and the top cover panel 18, with the connecting means 22 being designed as a strap-like arrangement on the support profile 15 and protruding radially inwards into the ceiling assembly 12. In this way, an advantageous load transfer from the ceiling assembly 12 can take place both to the barrel element 11 and additionally or exclusively to the support profile 15. At the bottom is shown the turnstile 10, on which the ceiling device 19 is arranged to rotate with it.

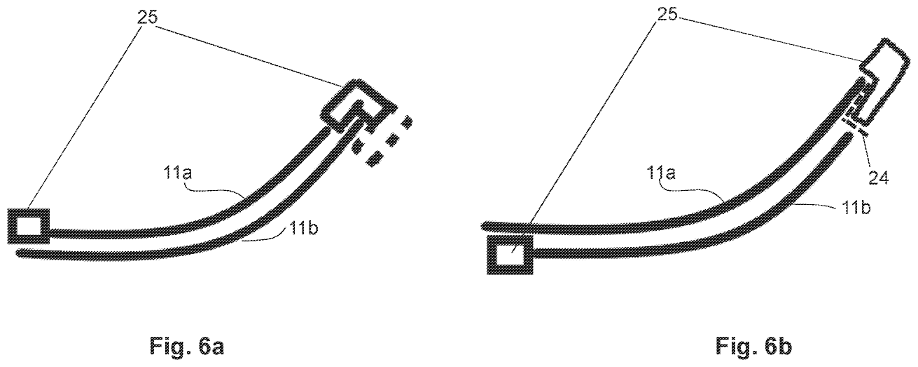

FIGS. 6a and 6b each show a top view of a barrel element. A lateral offset between the inner and outer glass element 11a, 11b is thereby visible, in which a support profile 25 is arranged. According to FIG. 6b, a lateral profile element 24 is arranged between the elements, which simplifies the connection. Of course, sub-combinations of each of the options shown for the integration of the support profile 25 on/into the barrel element can be in accordance with the disclosure. An embodiment of this type improves the integration of the support profile 25 in the revolving door visibly and statically. The support profile 15 described above can also be designed according to this example.

The design of the disclosure is not restricted to the preferred exemplary embodiment indicated above. In fact, a number of variants is conceivable which make use of the represented solution even in the case of fundamentally different designs. All features and/or advantages emerging from the claims, the description or the drawings, including constructive details or spatial arrangements, may be essential to the disclosure by themselves and in the most varied combinations.

1. A revolving door with a turnstile which is arranged between opposing barrel elements and with a ceiling assembly which is arranged on top of the barrel elements and on which the turnstile is rotatably mounted,
wherein the barrel elements each have an inner glass element and an outer glass element, wherein the ceiling assembly is directly or indirectly on a top finishing surface of the inner glass element and/or on a top finishing surface of the outer glass element.

2. The revolving door according to claim 1,
wherein the inner glass element has a shorter vertical length than the outer glass element such that the outer glass element encloses the ceiling assembly at least partially or entirely on the outside.

3. The revolving door according to claim 1,
wherein the vertical length of the inner glass element is shorter than the vertical length of the outer glass element by at least 20% to 100% of the height dimension of the ceiling assembly.

4. The revolving door according to claim 1,
wherein the inner glass element and the outer glass element are connected to one another in a materially-bonded manner.

5. The revolving door according to claim 1,
wherein the inner glass element and the outer glass element are connected to one another by means of at least one plastic film.

6. The revolving door according to claim 1,
wherein at least one profile element is provided, which rests on the top finishing surface of the inner glass element and/or the top finishing surface of the outer glass element, wherein the ceiling assembly is accommodated in or on the profile element.

7. The revolving door according to claim 6,
wherein the profile element is adhered to the inner glass element and/or to the outer glass element.

8. The revolving door according to claim 6,
wherein the profile element has a first leg and a second leg perpendicular to the first leg such that the profile element has an L-shape or T-shape or Z-shape, wherein the first leg rests on the finishing surface of the inner glass element and/or wherein the second leg adjoins the inside of the outer glass element.

9. The revolving door according to claim 1,
wherein at least one region of the outer glass element, which surpasses the inner glass element in height, has a coating or is colored.

10. The revolving door according to claim 1,
wherein at least one support profile is configured on the outside of the barrel elements and has a supporting connection with the ceiling assembly.

11. The revolving door according to claim 1,
wherein the ceiling assembly has a sandwich design with a bottom cover panel, a filler and a top cover panel.

12. The revolving door according to claim 1,
wherein the ceiling assembly forms an assembly configured to be handled individually and configured to be attached to the barrel elements and/or the turnstile, and configured to be detached from the barrel elements and/or the turnstile.

13. A method for assembling a revolving door, according to claim 1, wherein the method includes at least the following steps:
connecting an inner, curved, glass element, which is shorter in height, to an outer, curved, glass element, which is longer in height;
positioning the barrel elements in an opposing arrangement; and
directly or indirectly placing a ceiling assembly on a top finishing surface of the inner glass element and/or on a top finishing surface of the outer glass element.

14. The method according to claim 13,
whereby forming the barrel elements, the inner glass elements are adhered to the outer glass elements in a materially-bonded manner or are connected to one another with at least one film.

15. The method according to claim 13,
whereby the ceiling assembly is adhered to the barrel elements, by arranging a profile element on the inner glass element and/or on the outer glass element.
